(19) United States
(12) Patent Application Publication
(10) Pub. No.: US 2010/0279594 A1
(43) Pub. Date: Nov. 4, 2010

(54) Protective device having one or more optical sheet layers

(76) Inventors: David K. Peeler, Evans, GA (US); Johnetta C. George, Aiken, SC (US)

Correspondence Address: J. BENNETT MULLINAX, LLC, P. O. BOX 26029, GREENVILLE, SC, 29616-1029, US

(21) Appl. No.: 11/546,640

(22) Filed: Oct. 12, 2006

Related U.S. Application Data
(60) Provisional application No. 60/815,070, filed on Jun. 20, 2006.

(51) Int. Cl. B08B 15/02

(52) U.S. Cl. 454/49

(57) ABSTRACT

A protective device for use in a hazardous environment that is at least partially isolated from a user is provided. The protective device includes a plurality of layers made of a film for attachment to a surface. The layers are removably attachable to one another so that when one of the layers becomes impaired through exposure to the environment the impaired layer is capable of being removed from the remaining layers in order to restore the protective device.

### CROSS REFERENCE TO RELATED APPLICATION

This application claims the benefit of U.S. Application Ser. No. 60/815,070 filed on Jun. 20, 2006 and entitled, “Protective Device Having One or More Optical Sheet Layers.” U.S. Application Ser. No. 60/815,070 is incorporated by reference herein in its entirety for all purposes.

### STATEMENT AS TO RIGHTS TO INVENTIONS MADE UNDER FEDERALLY SPONSORED RESEARCH AND DEVELOPMENT

This invention was made with Government support under Contract No. DE-AC09-96-SR18500 awarded by the United States Department of Energy. The Government has certain rights in the invention.

### FIELD OF THE INVENTION

The present invention relates generally to a protective device for use in a harsh environment. More particularly, the present application involves a protective device with one or more optical sheet layers used to protect windows such as cell windows, glove box windows, chemical hood windows or surfaces exposed to harsh environments.

### BACKGROUND

A shielded cell or isolator is employed in order to house potentially lethal and dangerous materials and radioactivity. Materials and objects located within the isolator are sometimes manipulated through the use of a remote device. Often, such isolators have a cell window through which an operator may view the interior in order to observe or manipulate the housed material. In addition, a window shield layer may be placed on the inside of the isolator in order to protect the cell window. The window shield layer may be made of a high durable polycarbonate resin thermoplastic such as LEXAN® which is manufactured by GE Plastics having offices at 1 Plastics Avenue, Pittsfield Mass. 01201.

Over time, visual clarity of the window or window shield layer deteriorates due to exposure to the harsh environment in the isolator. Vapor from acids in the isolator may act to damage the window shield layer or window. Such etching of the window or window shield layer is sometimes referred to as “frosting.” Further, splashes from acids or bases in the isolator onto the window shield layer or window may also act to damage and visibly degrade the layer. Accidental scratching of the window shield layer or window is possible due to the presence of manipulators and tools in the isolator which are used to handle materials and conduct procedures therein. Further, the presence of radiation in the isolator may also act to damage and degrade the visual clarity of the window shield layer or window. Various other items such as slurries, solutions, particulates, dust and aerosols to name but a few could also act to degrade the clarity of the window or window shield layer. As the visual clarity of the window or window shield layer decreases, the ability of the user to view items and perform procedures within the isolator diminishes.

In order to restore visual clarity to the cell window, the window shield layer or window may be replaced. Replacement may be performed at specific intervals of time or on an “as needed” basis once it becomes too difficult to view the inside of the isolator. Replacement can be accomplished by removing the entire damaged window assembly and installing a new, undamaged window assembly. Alternatively, replacement can be accomplished by cutting a new piece of the window shield layer to the correct size and retrofitting the window shield layer with handles capable of being manipulated by equipment in use in the isolator. The window shield layer is transferred into the isolator and mounted into place. Subsequently, the window shield layer that was replaced may require size reduction prior to appropriate disposal. Disposal of the window shield layer is time consuming and costly as the window shield layer is made of a rigid material and must normally be size-reduced for bulk disposal. Likewise, replacement and disposal of an entire, damaged window assembly is time consuming and costly. The incorporation of additional protective devices in addition to the window shield layer is avoided as it would introduce additional elements into the hazardous environment hence necessitating their removal and disposal. As additional protective devices would most likely be contaminated, disposal would be both time intensive and expensive.

Aside from cell windows, fume hoods and glove boxes also require visual access for the user. These devices are not normally fitted with a window shield layer as in the isolator. Once the glove box or the hood sash window becomes visually degraded through use the entire window in the device is removed and replaced in order to regain visual clarity. Replacement of an entire window of one of these devices results in potential exposure issues to personnel and bulk waste disposal of the window which is both time consuming and costly.

Accordingly, there remains room for variation and improvement within the art.

### SUMMARY

Various features and advantages of the invention will be set forth in part in the following description, or may be obvious from the description, or may be learned, from practice of the invention.

The present invention provides for a fume hood for use in performing a procedure. The fume hood includes a procedure area for the conduction of procedures that result in the production of fumes. However, it is to be understood that the presence of other items such as acids, bases, slurries, solutions, equipment, particulates, dust and aerosols to name but a few could also be present. An exhaust is present and is in communication with the procedure area. The exhaust is used to remove fumes from the procedure area. A window made of transparent material is also included to allow a user to view the procedure area. A protective device is present that has at least one layer that is configured for being removed once the layer becomes visually impaired through exposure to conditions in the procedure area.

Also provided in accordance with another aspect of the present invention is a fume hood as immediately discussed in which the protective device is configured for use with the window. The protective device is arranged so that the procedure area is viewable by the user through the protective device and the window.

A further aspect of the present invention exists in a fume hood as discussed above in which the protective device has a plurality of layers. The layers are configured for being removed individually upon becoming visually impaired through exposure to conditions in the procedure area.

The present invention also provides for a glove box for use in performing a procedure. The glove box includes a compartment defined by a plurality of walls. A window made of a transparent material is present and allows a user to view the compartment. Also included is a protective device that has at least one layer. The layer is configured for being removed once it becomes visually impaired through exposure to conditions in the compartment.

Another aspect of the present invention is found in a glove box as immediately discussed in which the protective device has a plurality of layers made of a transparent material. The layers are configured for being removed individually upon becoming visually impaired through exposure to conditions in the compartment. The protective device is contiguous with the window in order to protect the window from damage from conditions in the compartment.

The present invention also provides, in an additional aspect, for a glove box as immediately discussed in which each layer of the protective device has a tab. The tabs are configured to be pulled in order to effect removal of the corresponding layer. The layers are held onto one another through an attachment selected from the group of static compression and an adhesive.

A further aspect of the present invention resides in a glove box as discussed above in which at least one layer of the protective device is made of a polyester film and has an ultimate strength in the machine direction from 15 to 25 kg/mm².

Also provided in another aspect of the present invention is a protective device for use in a hazardous environment that is at least partially isolated from a user. The protective device includes a plurality of layers made of a film for attachment to a surface. The layers are removably attachable to one another so that when one of the layers becomes impaired through exposure to the environment the impaired layer is capable of being removed from the remaining layers in order to restore the protective device.

Another aspect of the present invention exists in a protective device as immediately discussed in which the layers are transparent.

A further aspect of the present invention resides in a protective device as discussed above in which the layers are configured for use with a window so that the environment is viewable through the layers and the window.

Yet another aspect is found in a protective device as immediately discussed in which one of the layers is attached to a transparent window shield layer. The environment is viewable through the layers, the window shield layer and the window.

A further aspect of the present invention is found in a protective device as discussed above in which the plurality of layers are attached to a surface of a device that is selected from the group consisting of an isolator, a glove box and a fume hood.

Another aspect of the present invention is found in a protective device as discussed prior in which the plurality of layers are made of a polyester film and have an ultimate strength in the machine direction from 15 to 25 kg/mm².

A further aspect of the present invention is found in a method of restoring visual clarity through a window assembly. The method includes the step of providing a window made of a transparent material. Also, a protective device that has a plurality of layers made of a transparent film that are removably attachable to one another is oriented with respect to the window. A user can view an interior space that has a hazardous environment through the window and the protective device so that the protective device protects the window from the hazardous environment. The method also includes the step of removing one of the layers of the protective device after the layer becomes visually impaired through exposure to the hazardous environment. Removal of the visually impaired layer restores visual clarity so that the user can more clearly view the interior space.

A further aspect of the present invention is found in a method as immediately discussed in which the layers are held onto one another through an attachment selected from the group of static compression and an adhesive. Each layer of the protective device has a tab. The removing step includes pulling the tab of the layer in order to effect removal of the layer.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of the interior of an isolator that employs a window assembly in accordance with one exemplary embodiment of the present invention.

FIG. 2 is a perspective view of a window assembly in accordance with one exemplary embodiment of the present invention.

FIG. 3 is a side view of the window assembly of FIG. 2.

FIG. 4 is a perspective view of a window assembly that has visual degradation in accordance with one exemplary embodiment of the present invention.

FIG. 5 is a perspective view of the window assembly of FIG. 4 after a layer of the protective device is removed in order to restore visual clarity to the window assembly.

FIG. 6 is a perspective view of a fume hood in accordance with another exemplary embodiment of the present invention.

FIG. 7 is a perspective view of a glove box in accordance with another exemplary embodiment of the present invention.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to about 7 also includes a limit of up to about 5, up to about 3, and up to about 4.5.

The present invention provides for a protective device 16 that may be incorporated into a window assembly 10 in order to provide for both protection and the enablement of visual clarity. The protective device 16 may be incorporated into a window assembly 10 of a shielded cell or isolator 38. Acids, bases, slurries, solutions, radiation, and manipulators 34 in the isolator 38 act to degrade the visual clarity of the window assembly 10. The protective device 16 includes one or more layers 18, 20, 22 and 24 that are positioned on the interior side of window assembly 10 so that the interior most layer 18 is exposed to the harsh environment of the isolator 38. Once layer 18 becomes visually degraded it may be removed from the protective device 16 and discarded so that visual clarity is restored to the protective device 16 and hence window assembly 10. Removal and disposal of the layers 18, 20, 22 and 24 of the protective device 16 may be accomplished in a fast and efficient manner.

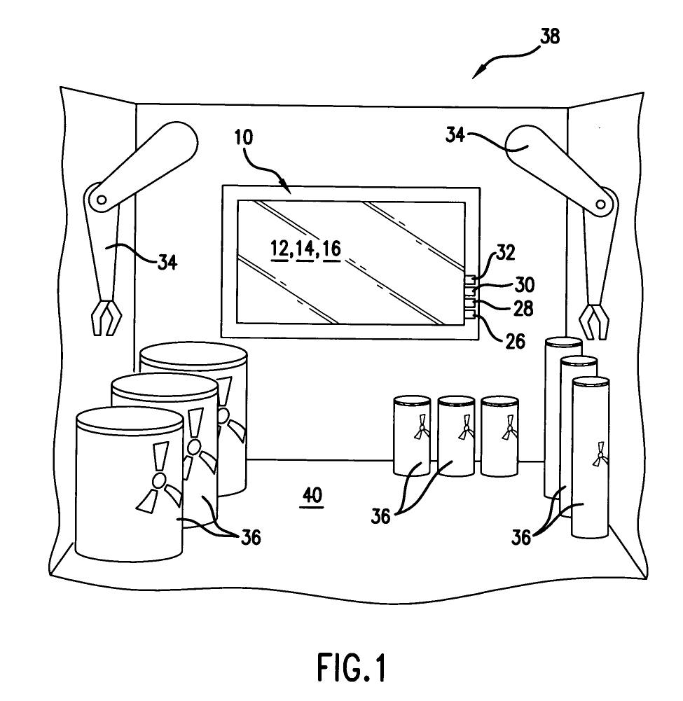

One exemplary embodiment of the protective device 16 incorporated into a window assembly 10 of an isolator 38 is shown in FIG. 1. Here, the window assembly 10 is located in a wall of the isolator 38 and allows a user to view the interior 40 of the isolator 38. The interior 40 houses several canisters 36 along with a manipulator 34 that is used to access and perform procedures relating to canisters 36. It is to be understood, however, that various types of equipment may or may not be present in the isolator 38 and that the presence of the canisters 36 and manipulator 34 is made for sake of example. The canisters 36 can contain any type of hazardous material. The canisters 36 may contain any type of hazardous materials or chemicals such as acids, bases or sludge. Further, the canisters 36 or their contents may be radioactive. Hazards such as fumes, splashes and/or radioactivity from canisters 36 may act to visibly degrade the window assembly 10. Additionally or alternatively, the manipulator 34 may inadvertently hit the window assembly 10 and cause chipping or scratching thereon that further hinders the ability to see through the window assembly 10.

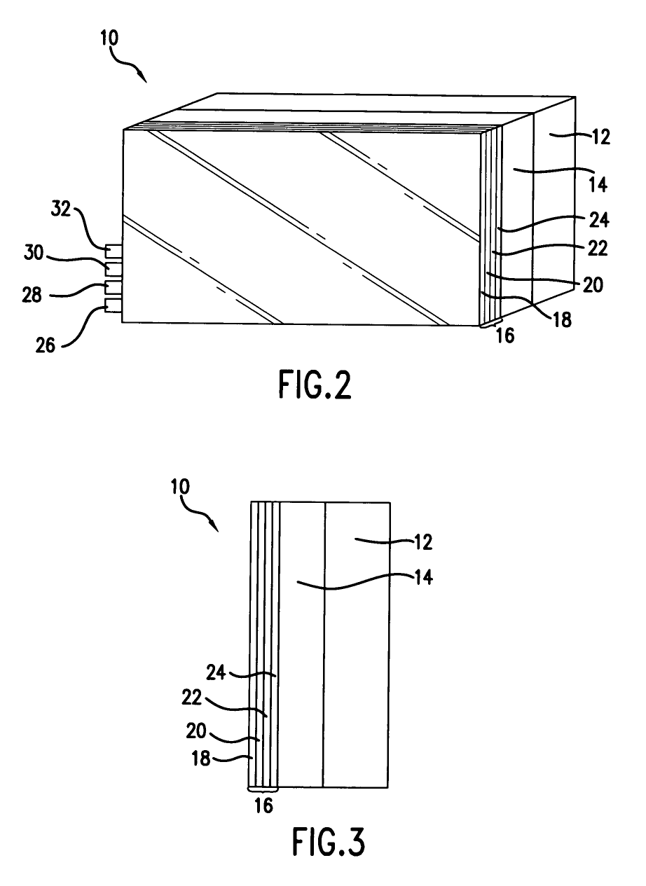

FIG. 2 shows the window assembly 10 of FIG. 1. The window assembly 10 includes a window 12 that may be made out of standard glass or acrylic. A window shield layer 14 is provided and is located so as to face the interior 40 of the isolator 38 with respect to the window 12. The window shield layer 14 is made out of LEXAN® in accordance with one exemplary embodiment. A protective device 16 is contiguous with the window shield layer 14 and is oriented thereto so as to face the interior 40 of isolator 38. The protective device 16 is made of a plurality of layers 18, 20, 22 and 24. The layers 18, 20, 22 and 24 may be made of any type of film. For example the layers 18, 20, 22 and 24 may be made of polyester film. Preferably, the layers 18, 20, 22 and 24 should be selected so that they exhibit some degree of resistance to the harsh environment to which they are exposed in the interior 40 of the isolator 38. Also, the layers 18, 20, 22 and 24 should be selected so that they exhibit adequate optical properties such that a user may see through the layers 18, 20, 22 and 24.

In accordance with one exemplary embodiment, the layers 18, 20, 22 and 24 are made of MYLAR® polyester film which is distributed by DuPont Teijin Films having offices at 1 Discovery Drive, PO Box 411, Hopewell, Va. 23860. Physical and thermal properties of the film making up the layers 18, 20, 22 and 24 may be found in U.S. Application Ser. No. 60/815,070 filed on Jun. 20, 2006 and entitled, “Protective Device Having One or More Optical Sheet Layers,” the entire contents of which are incorporated by reference herein in their entirety for all purposes. Additionally, the chemical properties of the film making up layers 18, 20, 22 and 24 may also be found in U.S. Application Ser. No. 60/815,070. The layers 18, 20, 22 and 24 may be relatively thin with respect to the window shield layer 14 so that, for example, the layers 18, 20, 22 and 24 may be less than one fourth or less than one tenth the thickness of the window shield layer 14. In accordance with one exemplary embodiment of the present invention, the layers 18, 20, 22 and 24 are four mils thick (0.004 inches or 101.6 microns). However, it is to be understood that the aforementioned ratios between the size of layers 18, 20, 22 and 24 and window shield layer 14 are made only for sake of example and that these components may be variously sized with respect to one another in accordance with other exemplary embodiments. The layers 18, 20, 22 and 24 can be held onto one another through an attachment selected from the group of static compression and an adhesive. In one embodiment either static compression or an adhesive can be used to hold one or more of the layers 18, 20, 22 and 24 to another. Additional embodiments are also possible in which both static compression and adhesive are used to hold layers 18, 20, 22 and 24 to one another.

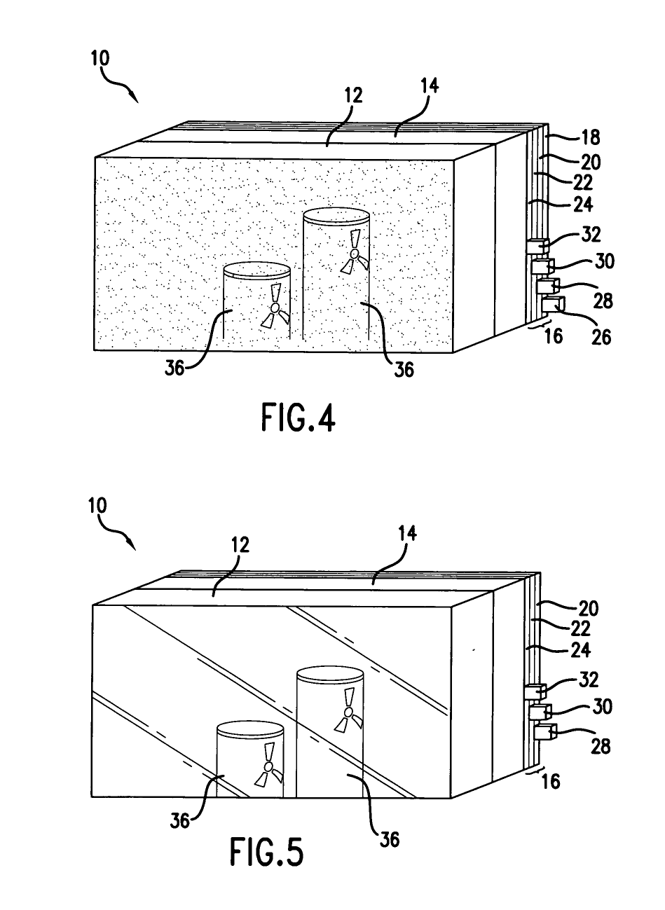

FIG. 4 shows an exemplary embodiment of the window assembly 10 in which the protective device 16 includes layers 18, 20, 22 and 24. The window assembly 10 has been subjected to harsh conditions such that “frosting” has occurred on the protective device 16. The visual integrity of window assembly 10 has degraded so that it becomes hard to see through in order to view the canisters 36 or perform operations or procedures with the manipulators 34. Here, the first layer 18 of the protective device 16 faces the interior 40 of the isolator 38 or other structure to which the protective device 16 is incorporated. The first layer 18 is thus damaged by vapors, spills, radiation and/or accidental scratching which results in damage to the first layer 18 and hence diminishes the optical properties of the window assembly 10.

A first tab 26 is attached to the first layer 18. A user may pull the first tab 26 so that the first layer 18 is removed from the second layer 20. The first tab 26 may be made of the same material or may be made of a different material from the material making up the first layer 18. In some instances, the user can grasp and remove the first tab 26 through the use of manipulator 34. This procedure results in the removal of the damaged first layer 18 from the protective device 16 and hence restores the optical properties of the window assembly 10 as the second layer 20 is not visually or mechanically damaged as it was covered by the first layer 18 and not exposed to the interior 40. It is to be understood, however, that in some instances multiple layers of the protective device 16 may be damaged in other embodiments. For example, it may be the case that the manipulator 34 hits the window assembly 10 with a force great enough to tear or scratch any number of layers 18, 20, 22 and 24 aside from only the one exposed to the interior 40.

Removal of the damaged first layer 18 causes the second layer 20 to be exposed to the interior 40 and improves the optical properties of the window assembly 10. Removal of the first layer 18 and resulting clarity of the window assembly 10 is shown in FIG. 5. In addition to restoring clarity, removal of the first layer 18 exposes the second layer 20 and makes it the next layer of protection of the protective device 16. It is easier to dispose of the first layer 18 as layer 18 is relatively thin and flexible enough to be capable of collapsing. As such, it may not be necessary to cut the first layer 18 into smaller pieces for disposal. It may be the case that providing the window assembly 10 with a protective device 16 reduces the amount of bulk waste that needs to be disposed from the isolator 38. Further, as the length of life of the layered protective device 16 is longer, the number of isolator 38 entries needed to replace the window shield layer 14 and/or window 12 is reduced. An increase in the time interval necessary to replace the window shield layer 14 reduces the cost of maintaining the window assembly 10. Applicants have estimated that the use of the protective device 16 into applications that involve a radioactive background or environment may eliminate replacement costs on the order of $200,000 to $400,000 through savings in material, labor and downtime. The aforementioned cost range may be based per change out of the window shield layer 14 which may occur as frequently every 3 to 5 years. This frequency could depend on several factors which may vary from site to site.

Once the second layer 20 becomes damaged, hence resulting in a decrease in the visual properties of the window assembly 10, the second tab 28 may be pulled in order to separate the second layer 20 from the third layer 22. Subsequent damage to the third layer 22 necessitates its removal by pulling on third tab 30 in order to separate third layer 22 from the fourth layer 24. Once the fourth layer 24 becomes damaged through exposure to conditions in the interior 40, the fourth layer 24 may be removed from the window shield layer 14 by pulling the fourth tab 32 in order to restore optical clarity to the window assembly 10. The window shield layer 14 may need to be replaced once it becomes damaged through exposure to conditions in the interior 40. As an alternative arrangement, once the fourth layer 24 is removed, the user may install a new protective device 16 onto the window shield layer 14 so that additional layers 18, 20, 22 and 24 may be subsequently removed instead of the window shield layer 14. Although shown as having a single tab 26, 28, 30 and 32 incorporated into each of the layers 18, 20, 22 and 24, it is to be understood that two or more tabs may be provided on any one of the single layers 18, 20, 22 or 24. This may be advantageous when the protective device 16 has a large size when incorporated into large windows 12. Further, the second tab could be used as a back-up tab should the primary tab 26, 28, 30 or 32 fail. As such, various exemplary embodiments exist in which multiple tabs are used with the layers 18, 20, 22 and 24.

Although described as employing four layers 18, 20, 22 and 24, it is to be understood that any number of layers may be used in accordance with various exemplary embodiments of the present invention. For example, in accordance with one embodiment, only a single layer 18 is included in the protective device 16. Alternatively, up to ten layers or up to twenty layers may be incorporated into the protective device 16. Further, the protective device 16 may include between two and twenty-five layers. In other embodiments, the protective device 16 may include any number of layers. The protective device 16 acts as a primary protective layer while the window shield layer 14 acts as a secondary protective layer. Although not described as a protective layer, the window 12 of the window assembly 10 itself also provides protective properties in the isolator 38. In some instances, the window 12 is approximately three feet thick and includes two sheets of Pb-based glass filled with oil. In other embodiments, the isolator 38 may be constructed so that the window shield layer 14 is not present. Here, the protective device 16 is attached directly to the window 12. The protective device 16 thus affords the only means of protection to the window 12. Although described as protecting against radiation, it may be the case that gamma radiation penetrates the entire protective device 16 and not just the outer, first layer 18. However, in these instances the gamma radiation does not cause visual or mechanical degradation to the layers 18, 20, 22 and 24 so they may be used in the described manner. Alpha radiation may not penetrate all of the layers 18, 20, 22 and 24 of the protective device 16 and may therefore be stopped by the outer, first layer 18.

Applicants have conducted tests in accordance with the present invention in which a protective device 16 including layers 18, 20, 22 and 24 made of MYLAR® was incorporated into a window assembly 10. Such tests are discussed in Appendix C of previously incorporated U.S. Application Ser. No. 60/815,070 entitled, “Protective Device Having One or More Optical Sheet Layers.” The window assembly 10 performed as well as a window assembly 10 without the protective device 16 that had a window 12 made of LEXAN®. As such, incorporation of the protective device 16 into the window assembly 10 employing the window 12 made of LEXAN® would extend the life of this window assembly 10 by at least a factor of four. Based on this test, it is the case that the placement of the aforementioned protective device 10 into a window assembly 10 having a glass window 12 would act to increase the life of the window assembly 10 also by at least a factor of four.

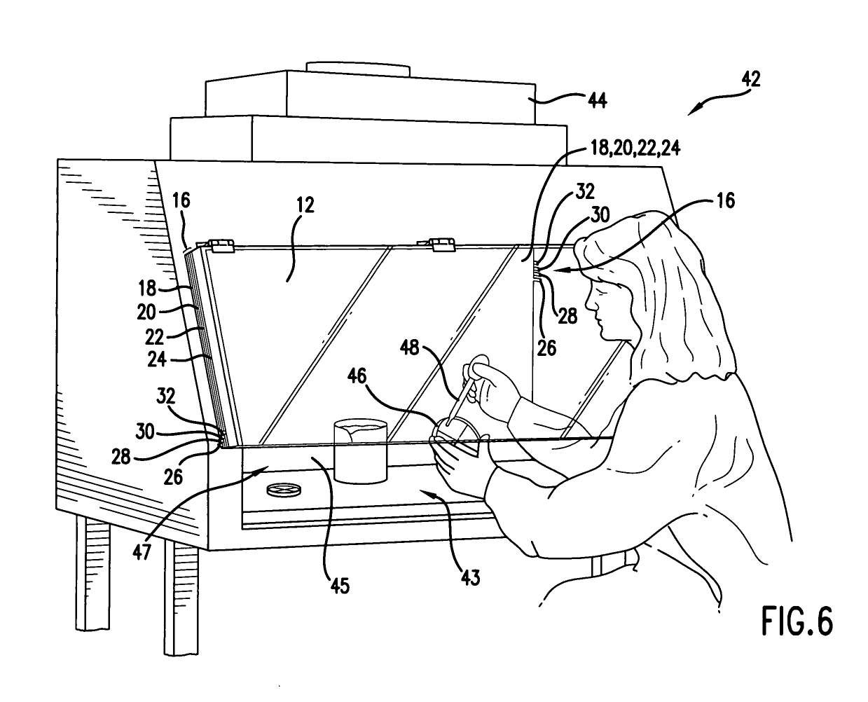

The protective device 16 can be incorporated into newly constructed window shield layers 14 or may be retrofit thereon. Although described as being used in a window assembly 10 of an isolator 38, the protective device 16 can be used in other applications. For example, the protective device 16 can be applied to fume hoods, chemical hoods or radiochemical hoods. FIG. 6 shows the protective device 16 used in conjunction with a fume hood 42. The fume hood 42 has an opening 43 below a sash window 12 that affords a user access to the procedure area 47 of the fume hood 42. The user can perform procedures in the procedure area 47 such as the application of an agent 48 to an object 46. The agent 48 may be a hazardous substance like an acid or base. The fume hood 42 creates a negative pressure therein that draws hazardous fumes upwards and away from the opening 43 below window 12 so that the user outside of the fume hood 42 is not exposed. Fumes are purified and are expelled from the fume hood 42 though a ductless exhaust 44. Other fume hoods 42 exist in which the exhaust 44 is connected to a duct that is in turn in communication with the exhaust system of the building.

As the window 12 of the fume hood 42 is exposed to hazardous substances, the protective device 16 is incorporated in order to extend the life of the window 12. The protective device 16 is positioned on the window 12 and is located in the interior of the fume hood 42. Any number of layers 18, 20, 22 and 24 can be present in the protective device 16. As with previously described embodiments, once visual clarity through the window 12 becomes degraded, one of the layers 18, 20, 22 or 24 can be successively removed and disposed of in order to restore an optimal view through the window 12.

Although described as being used in conjunction with the window 12, the protective device 16 can also be used with other, non-transparent, surfaces of the fume hood 42. For example, the back wall 45 of the fume hood 42 can be covered with the protective device 16. Although the back wall 45 is not viewed therethrough, the back wall 45 can still become damaged and stained through exposure to agents 48 in the fume hood 42 or through contact with objects during the conducting of procedures therein. Placement of the protective device 16 onto the back wall 45 prevents the back wall 45 from being damaged. Once one layer 18, 20, 22 or 24 of the protective device 16 becomes stained or otherwise damaged, it can be removed in order to restore visual clarity to the back wall 45.

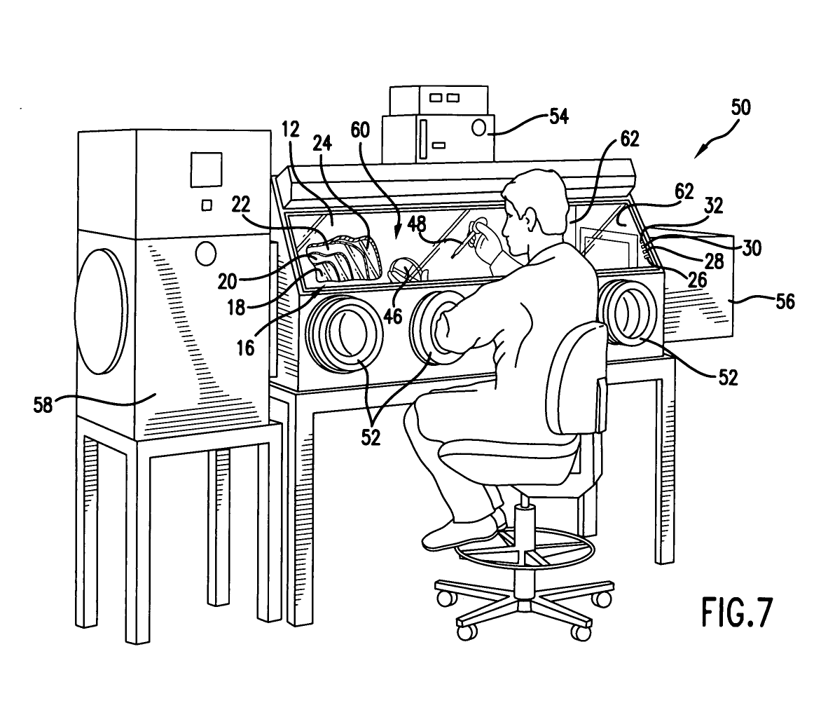

Another piece of equipment onto which the protective device 16 can be employed is a glove box 50 as shown in FIG. 7. The glove box 50 includes a controlled environment in which procedures can be performed. A gas mixer 54 is present in order to insert desired gases, such as helium and nitrogen, into a compartment 60 of the glove box 50 to achieve a desired environment therein. A pass-through oven 58 is present for degassing at elevated temperatures, and an air lock 56 can be used to remove objects treated in the compartment 60 of the glove box 50. The compartment 60 can be viewed through a window 12.

One or more glove ports 52 can be included in the glove box 50 to allow a user to manipulate objects 46 located therein. In certain instances, the environment inside of the compartment 60 can act to degrade the view through window 12. Additionally, agents 48 may be harsh substances such as acids or bases that can be splashed onto the window 12 or emit fumes that stain the window 12. The window 12 is also susceptible to scratching or chipping through contact with objects therein during the execution of procedures that likewise degrade the view therethrough. The glove box 50 can be fitted with a protective device 16 to protect window 12 and prevent the degradation of the view through window 12 thus extending its life. Layers 18, 20, 22 and 24 of window 12 can be removed once stained or damaged in order to restore visual clarity to window 12 in the same manner as previously discussed. In this regard, the user can use the glove ports 52 to pull a desired layer 18, 20, 22 or 24 from the protective device 16. The removed layer 18, 20, 22 or 24 can be taken from the interior of the glove box 50 through the air lock 56. A portion of window 12 is cut away in FIG. 7 simply for purposes of clarity in the drawing and it is to be understood that this cut away section is present in use. Although described as being used to protect window 12, the protective device 16 could additionally or alternatively be used to protect one or more of the walls 62 that define the compartment 60.

The protective device 16 can be used in any system that requires visual access through a window or port that is susceptible to damage due to inherent environmental conditions. As such, the environment into which the protective device 16 is exposed is harsher than the environment into which the user is located. Also, it is to be understood that the protective device 16 can be used in other manners apart from being incorporated into a window 12. The protective device 16 can be used in situations where damage needs to be mitigated in order to extend service life. The protective device 16 can be used to protect any surface against damage from a harsh environment. For example as discussed, the internal walls or body of a radiochemical fume hood other than the window 12 may be provided with the protective device 16 for protection from exposure to acid vapors. In a similar manner, walls in the isolator of FIG. 1 can have the protective device 16 applied thereto.

The protective device 16 can also find utility in various military applications in addition to or alternatively to finding use in the pharmaceutical and/or medical field. For example, the protective device 16 can be incorporated into a barrier that is used to protect the patients and health care providers from specific environments. The protective devices 16 could also be used in the manufacture, testing or distribution of drugs in the pharmaceutical field.

As shown in the figures, the protective device 16 includes layers 18, 20, 22 and 24 that are all of the same size and extend across the entire surface of the protective device 16. Other exemplary embodiments exist in which the protective device 16 is made of two or more pieces that are each layered. This type of configuration may allow for certain areas of the protective device 16 to have layers 18, 20, 22 or 24 removed to restore visual clarity without having to remove a layer of the entire protective device 16. It is to be understood that various exemplary embodiments are present in which an entire layer or only a portion of a layer of the protective device 16 may be removed in order to restore visual clarity therethrough.

Although described as being transparent, the protective device 16 may be semi-transparent or non-transparent in other embodiments. In certain circumstances it may be desirable to have a tinted protective device 16 in order to enhance visual clarity. In these instances, one or more of the layers of the protective device 16 may be tinted. Additionally, the window 12 and/or the window shield layer 14 can be tinted. Other applications may require the use of a protective device 16 that is non-transparent. Here, the protective device 16 may have colored layers that are used to protect different types of surfaces. Additionally, although described as being used in relation to acids, bases, slurries, solutions, radiation, and equipment, it is to be understood that the protective device 16 can be used as protection against any type of agent such as particulates, dust and aerosols to name but a few.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A fume hood for use in performing a procedure, comprising:
a procedure area for use in conducting procedures that result in the production of fumes;
an exhaust in communication with said procedure area for use in removing fumes from said procedure area;
a window made of a transparent material to allow a user to view said procedure area; and
a protective device having at least one layer that is configured for being removed once said layer becomes visually impaired through exposure to conditions in said procedure area.

2. The fume hood as in claim 1, wherein said protective device is configured for use with said window such that said procedure area is viewable by the user through said protective device and said window.

3. The fume hood as in claim 1, wherein said protective device is attached to a non-transparent wall that at least partially defines said procedure area.

4. The fume hood as in claim 1, wherein said procedure area is accessible by a user through an opening defined below said window.

5. The fume hood as in claim 1, wherein said protective device has a plurality of layers that are configured for being removed individually upon becoming visually impaired through exposure to conditions in said procedure area.

6. The fume hood as in claim 5, wherein each layer of said plurality of layers has a tab configured to be pulled so as to effect removal of said layer, and wherein said layers are held onto one another through static compression.

7. The fume hood as in claim 1, wherein said at least one layer of said protective device is made of a polyester film and has an ultimate strength in the machine direction from 15 to 25 kg/mm².

8. A glove box for use in performing a procedure, comprising:
a compartment defined by a plurality of walls;
a window made of a transparent material to allow a user to view said compartment; and
a protective device having at least one layer that is configured for being removed once said layer becomes visually impaired through exposure to conditions in said compartment.

9. The glove box as in claim 8, wherein said protective device has a plurality of layers made of a transparent material that are configured for being removed individually upon becoming visually impaired through exposure to conditions in said compartment, and wherein said protective device is contiguous with said window so as to protect said window from damage from conditions in said compartment.

10. The glove box as in claim 9, wherein each layer of said protective device has a tab configured to be pulled so as to effect removal of said layer, and wherein said layers are held onto one another through an attachment selected from the group consisting of static compression and adhesion.

11. The glove box as in claim 8, wherein said glove box has a plurality of glove ports for use in allowing a user to manipulate objects in said compartment and to remove said layer after becoming visually impaired.

12. The glove box as in claim 8, wherein said at least one layer of said protective device is made of a polyester film and has an ultimate strength in the machine direction from 15 to 25 kg/mm².

13. A protective device for use in a hazardous environment at least partially isolated from a user, comprising:
a plurality of layers made of a film for attachment to a surface, wherein said layers are removably attachable to one another such that when one of said layers becomes impaired through exposure to the environment said impaired layer is capable of being removed from said remaining layers in order to restore said protective device.

14. The protective device as in claim 13, wherein said layers are transparent.

15. The protective device as in claim 13, wherein said layers are configured for use with a window such that the environment is viewable by the user through said layers and the window.

16. The protective device as in claim 15, wherein one of said layers is attached to a transparent window shield layer, such that the environment is viewable by the user through said layers, the window shield layer and the window.

17. The protective device as in claim 13, wherein the surface to which said plurality of layers is attached is non-transparent.

18. The protective device as in claim 13, wherein said plurality of layers are attached to a surface of a device selected from the group consisting of an isolator, a glove box and a fume hood.

19. The protective device as in claim 13, wherein said plurality of layers are made of a polyester film and have an ultimate strength in the machine direction from 15 to 25 kg/mm².

20. The protective device as in claim 13, wherein each layer of said plurality of layers has a tab configured to be pulled so as to effect removal of said layer, and wherein said layers are held onto one another through static compression.

21. A method of restoring visual clarity through a window assembly, comprising the steps of:
providing a window made of a transparent material;
orienting a protective device having a plurality of layers made of a transparent film that are removably attachable to one another with respect to said window such that a user can view an interior space having a hazardous environment through said window and said protective device such that said protective device protects said window from the hazardous environment; and
removing one of said layers of said protective device after said layer becomes visually impaired through exposure to the hazardous environment, wherein removal of said visually impaired layer restores visual clarity such that the user can more clearly view the interior space.

22. The method as in claim 21, further comprising the step of providing a transparent window shield layer and wherein said orienting step includes attaching said protective device to said window shield layer so that the hazardous environment is viewable by the user through said window, said protective device, and said window shield layer.

23. The method as in claim 21, wherein said layers are held onto one another through an attachment selected from the group consisting of static compression and adhesion, wherein each layer of said protective device has a tab, and wherein said removing step includes pulling said tab of said layer in order to effect removal of said layer.
